(19) United States
(12) Patent Application Publication
(10) Pub. No.: US 2026/0112097 A1
(43) Pub. Date: Apr. 23, 2026

(54) ELECTRONIC DEVICE AND METHODS FOR REAL-TIME VOICE BASED AVATAR INTERACTION

(71) Applicant: SAMSUNG ELECTRONICS CO., LTD., Suwon-si (KR)

(72) Inventors: Kunal SHARMA, Uttar Pradesh (IN); Putta Hemanth Kumar, Uttar Pradesh (IN)

(73) Assignee: SAMSUNG ELECTRONICS CO., LTD., Suwon-si (KR)

(21) Appl. No.: 19/427,379

(22) Filed: Dec. 19, 2025

Related U.S. Application Data
(63) Continuation of application No. PCT/KR2025/016611, filed on Oct. 20, 2025.

(30) Foreign Application Priority Data
Oct. 21, 2024 (IN) 202441080013

(51) Int. Cl. G06T 13/20; G06T 13/40; G06V 10/82; G06V 40/16; G10L 15/00; G10L 15/04; G10L 15/16; G10L 15/18; G10L 21/0208; G10L 25/63

(52) U.S. Cl. CPC G06T 13/205; G06T 13/40; G06V 10/82; G06V 40/171; G06V 40/174; G10L 15/005; G10L 15/04; G10L 15/16; G10L 15/1815; G10L 21/0208; G10L 25/63

(57) ABSTRACT

A method for generating a real-time voice based Avatar interaction, performed by an electronic device, includes, extracting one or more parameters from an audio input received from a user; adding one or more time stamps to the audio input based on the one or more extracted parameters; converting audio from the audio input into text; splitting the audio input with converted text into one or more intervals based on the one or more time stamps; extracting one or more emotions from the split audio input; identifying one or more facial features from the one or more extracted emotions; and animating an Avatar with the identified one or more facial features such that lip movements of the Avatar correspond with the audio input.

### CROSS-REFERENCE TO RELATED APPLICATION

This application is a continuation application of International Patent Application No. PCT/KR2025/016611, filed on Oct. 20, 2025, which claims priority from Indian Patent Application No. 202441080013, filed on Oct. 21, 2024, in the Indian Patent Office, the disclosures of which are incorporated herein by reference in their entireties.

### BACKGROUND

### 1. Field

Embodiments disclosed herein relate to Avatar animation, and more particularly to electronic device and methods for improving user interaction and engagement through user Avatar with audio message integration.

### 2. Description of Related Art

During message communications, many users prefer audio text when the information is lengthy, and for immediate communication. This is an effective method for a faster communication. However, the audio text may have lack of emotions, expressions and context, which makes it hard to understand the situation and feelings by just listening at audio message on revisiting or checking the chat.

In current audio messaging methods, a user can start an audio message on a positive note. Thereafter, the user can change his/her emotion to sad for another topic on the same audio message. Later, the user can change the emotion to disappointment. Finally, the user can end the message angrily for the same audio message. The user can only see the audio signal image on sending any audio message. After the conversation, users are left with emotionless audio signals which visually convey nothing.

Currently, Augmented Reality (AR) Avatars majorly support camera based interaction, lacking the ability to effectively handle real time audio messaging and Avatar video call which enhances the user experience in multiple levels. Existing AR Avatar systems often struggle with accurately synchronizing audio input with Avatar lip movement which degrades the user experience while using Avatars. Integrating real time audio messaging into AR Avatars presents significant technical challenges, including speech recognition, audio processing, and audio emotions. Like in text there are emotions present to express, similarly in audio messaging AR Avatars may express the mood and emotions of user.

In existing systems, AR Avatars have no proper lip sync, and expressions between the user and Avatar. The AR Avatar has delay of voice when Avatar starts to speak results in no coordination of the user and Avatar. The emotions may not be properly conveyed due to delay. Avatar was moved and altered depending on user camera movements, and highly coupled with user position and alignment with camera.

When the user uses the audio message while chatting and the conversation continuous with audio messages, the audio message visually convey nothing. While user might express multiple emotions in one single audio. User experience can get enhanced when the audio message is converted to AR video in real time.

AR/Virtual Reality (VR) technology can be used to enhance the user experience by converting the user audio into visually appealing video AR Avatars in real time while the user is still speaking. The existing Avatars are not convenient, and do not respond well when the user tries to talk. Therefore, the existing Avatars cannot be used for converting recorded audio message to video as the Avatar may not be fast in responding, the Avatar may not resemble the user, and also may not have lip sync with the audio.

Current AR Avatars primarily support text, and video based interaction, lacking the ability to effectively handle real-time audio messaging which effects on user experience. Existing AR Avatar systems often struggle to accurately synchronize audio input with Avatar lip movement which may degrade the user experience with Avatar.

Hence, there is a need in the art for solutions which will overcome the above mentioned drawback(s), among others.

### SUMMARY

Provided is an electronic device and method for integrating audio messaging capabilities with Augmented Reality (AR) Avatars, allowing users to send audio messages using their respective Avatars.

Provide is an electronic device and method for separating an input voice message into at least one timestamp based on recognized parameters of an audio input.

Provided is an electronic device and method for identifying a facial expression by comparing a selected unique facial expression with the separated voice message, wherein comparing includes matching recognized emotions from voice at different timestamp with the facial expressions.

Provided is an electronic device and method for embedding the identified facial expressions with the separated timestamp, and selecting at least one unique facial expression.

Provided is an electronic device and method for accurately animating Avatar facial expression and lip movement with no lips lagging, and with sender's facial look Avatar.

According to an aspect of the disclosure, a method for generating a real-time voice based Avatar interaction, performed by an electronic device, includes, extracting one or more parameters from an audio input received from a user; adding one or more time stamps to the audio input based on the one or more extracted parameters; converting audio from the audio input into text; splitting the audio input with converted text into one or more intervals based on the one or more time stamps; extracting one or more emotions from the split audio input; identifying one or more facial features from the one or more extracted emotions; and animating an Avatar with the identified one or more facial features such that lip movements of the Avatar correspond with the audio input.

The one or more extracted parameters may include at least one of an emotional aspect, an accent, a gender, and a pitch, and the one or more parameters may be extracted based on a Harmonics-to-Noise Ratio (HNR) using a Convolutional Neural Network (CNN) model.

The one or more time stamps may be added to the audio input by splitting the audio based on at least one person dataset or pitch dataset.

The method may further include removing noise from the received audio input, and the converting the audio into text may include converting the audio with noise removed into text.

The audio with noise removed may be converted into text using a DeepSpeech model, and the splitting the audio input may include detecting one or more languages spoken in the audio with noise removed, and detecting a timing of the one or more languages spoken in the audio with noise removed; and determining the one or more intervals based on the timing of the one or more languages spoken and the one or more time stamps.

The method may further include predicting a spoken language from the converted text; splitting the audio input with the converted text into the one or more intervals based on the spoken language; and extracting the one or more emotions from the split audio using an emotion transcript model including a CNN.

The method may further include extracting one or more features of the user from one or more media files stored in the electronic device, the one or more features including at least one of the one or more facial features and one or more object features; and creating a parcel using the one or more extracted features of the user.

The one or more features may be extracted from one or more images from among the one or more media files, and the one or more images may be determined based on at least one of mood, and timestamp of the audio input.

The method may further include analyzing at least one facial expression from the one or more facial features with a CNN model trained on an expression dataset; and creating the Avatar using the analyzed at least one facial expression, and the created parcel.

The method may further include passing the one or more extracted emotions and the created Avatar to a comparator; and suggesting one or more expressions from a facial expression database, based on a result of the comparator.

The Avatar may be created by based on a media file of the user, and the animating the Avatar may include mapping a face of the user using at least one facial recognition method; integrating the one or more extracted expressions with the created Avatar by mapping the one or more extracted emotions to the one or more suggested expressions; integrating real-time reactions with the created Avatar over at least one of the one or more intervals based on the one or more extracted emotions, and sentiment analysis of the converted text using a Natural Language Processing (NLP) model; and synchronizing lip movements of the created Avatar with the audio input based on mapping the converted text to the one or more extracted expressions.

According to an aspect of the disclosure, an electronic device includes, at least one processor; and memory storing instructions; wherein the instructions, when executed by the at least one processor, individually or collectively, cause the electronic device to extract one or more parameters from an audio input received from a user; add one or more time stamps to the audio input based on the one or more extracted parameters; convert audio from the audio input into text; split the audio input with converted text into one or more intervals based on the one or more time stamps; extract one or more emotions from the split audio input; identify one or more facial features from the one or more extracted emotions; and animate an Avatar with the identified one or more facial features such that lip movements of the Avatar correspond with the audio input.

The one or more extracted parameters may include at least one of an emotional aspect, an accent, a gender, and a pitch, and the one or more parameters may be extracted based on a Harmonics-to-Noise Ratio (HNR) using a Convolutional Neural Network (CNN) model.

The one or more time stamps may be added to the audio input by splitting the audio based on at least one person dataset or pitch dataset.

The instructions, when executed by the at least one processor, individually or collectively, may cause the electronic device to remove noise from the received audio input and convert the audio with the noise removed into text.

The audio with noise removed may be converted into text using a DeepSpeech model, and the instructions, when executed by the at least one processor, individually or collectively, may cause the electronic device to detect one or more languages spoken in the audio with noise removed, and detect a timing of the one or more languages spoken in the audio with noise removed; and determine the one or more intervals based on the timing of the one or more languages spoken and the one or more time stamps.

The instructions, when executed by the at least one processor, individually or collectively, may cause the electronic device to split the audio input with the converted text into the one or more intervals based on the spoken language;, and extract the one or more emotions from the split audio using an emotion transcript model including a CNN.

The instructions, when executed by the at least one processor, individually or collectively, may cause the electronic device to extract one or more features of the user from one or more media files stored in the memory, the one or more features may include at least one of the one or more facial features, and one or more object features; and create a parcel using the one or more extracted features of the user.

The one or more features may be extracted from one or more images from among the one or more media files, and the one or more images may be determined based on at least one of mood, and timestamp of the audio input.

According to an aspect of the disclosure, a non-transitory computer-readable recording medium having at least one instruction recorded thereon, that, when executed by at least one processor, individually or collectively, causes the at least one processor to extract one or more parameters from an audio input received from a user; add one or more time stamps to the audio input based on the one or more extracted parameters; convert audio from the audio input into text; split the audio input with converted text into one or more intervals based on the one or more time stamps; extract one or more emotions from the split audio input; identify one or more facial features from the one or more extracted emotions; and animate an Avatar with the identified one or more facial features such that lip movements of the Avatar correspond with the audio input.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a block diagram of an electronic device for generating a real-time voice based Avatar interaction, according to embodiments as disclosed herein;

FIG. 2 depicts a detailed system block diagram of the electronic device, according to embodiments as disclosed herein;

FIG. 3 depicts an example flow representation of extracting parameters and predicting a spoken language from the audio input, according to embodiments as disclosed herein;

FIG. 4 depicts an example block flow representation of an Avatar creation using the Avatar creation module, according to embodiments as disclosed herein;

FIG. 5 depicts an example block flow representation of the voice processing module for gender prediction and audio splitting with different pitch and persons, according to embodiments as disclosed herein;

FIG. 6A depicts an example block flow representation of the voice optimization module for noise reduction, according to embodiments as disclosed herein;

FIG. 6B depicts an example block flow representation of the voice optimization module for predicting languages, according to embodiments as disclosed herein;

FIG. 7A depicts an example block flow representation of generating a time emotions graph by the audio-to-text correlation module, according to embodiments as disclosed herein;

FIG. 7B depicts an example block flow representation of a parcel creation module of the audio-to-text correlation module, according to embodiments as disclosed herein;

FIG. 8 depicts an example block flow representation of the trained facial expression provider module of the facial expression database, according to embodiments as disclosed herein;

FIG. 9 depicts an example block flow representation of the emotion-driven expression module, according to embodiments as disclosed herein;

FIG. 10 depicts an example flow representation for generating a real-time voice based Avatar interaction by the electronic device, according to embodiments as disclosed herein;

FIG. 11 depicts a method for generating a real-time voice based Avatar interaction by the electronic device, according to embodiments as disclosed herein; and

FIG. 12 depicts a use case of E-Books and E-learning, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc. ”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc. ”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to facilitate understanding of various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The expressions “at least one of A, B and C” and “at least one of A, B, or C”, both indicate “A”, only “B”, only “C”, both “A and B”, both “A and C”, both “B and C”, and all of “A, B, and C”.

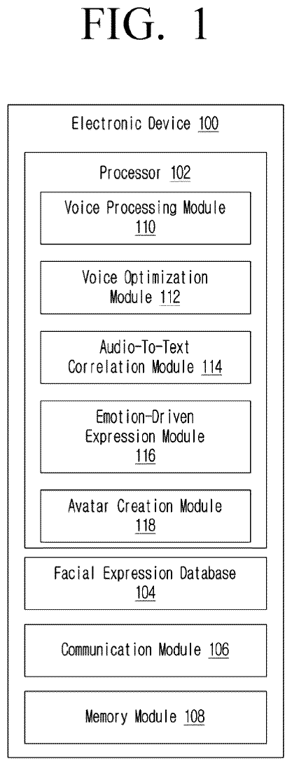

The embodiments herein disclose an electronic device and methods for integrating audio messaging capabilities with Augmented Reality (AR) Avatars, allowing users to send audio messages using their corresponding Avatars. Referring now to the drawings, and more particularly to FIGS. 1 through 12, where similar reference characters denote corresponding features consistently throughout the figures, there are shown embodiments.

FIG. 1 depicts a block diagram of an electronic device 100 for generating a real-time voice based Avatar interaction. The electronic device 100 comprises a processor 102, a facial expression database 104, a communication module 106, and a memory module 108. The processor 102 further comprises a voice processing module 110, a voice optimization module 112, an audio-to-text correlation module 114, and an emotion-driven expression module 116, and an Avatar creation module 118.

In an embodiment herein, the voice processing module 110 can receive an audio input received from a user, and extract one or more parameters from the received audio input. The parameters can include, but not limited to, an emotional aspect, an accent, a gender, and a pitch. The parameters can be extracted based on a Harmonics-to-Noise Ratio (HNR) using a Convolutional Neural Network (CNN) model. In an embodiment herein, the gender is extracted from the audio input using at least one of the CNN model, and a Recurrent Neural Network (RNN) model. The voice processing module 110 can add one or more time stamps to the audio input based on the extracted parameters. The time stamps can be added to the audio input by splitting the audio based on at least one person dataset or pitch dataset.

An emotional aspect refers to an aspect reflecting the emotional state of a user (e.g., happiness, sadness, anger, surprise, frustrated, shock, etc.). The term “emotional aspect” may alternatively be referred to as an “emotional characteristic”, an “emotional feature” and an “emotional state”.

A ‘person dataset’ refers to a collection of data associated with one or more individuals. The person dataset may comprises information on person who is speaking. The person dataset may include information on at least one of facial images, voice data, biometric signals, behavioral patterns, physical characteristics, or attributes enabling personal identification.

A ‘pitch dataset’ refers to a collection of data related to the pitch of voice or sound. The pitch dataset may include information on at least one of frequency spectra of speech signals, temporal pitch contours, and pitch characteristics with respect to gender, emotion, or language.

In an embodiment herein, the voice optimization module 112 can receive the audio input, and convert audio from the audio input into text. The voice optimization module 112 can remove noise from the received audio input, and convert the audio with noise removed into text. The voice optimization module 112 can split the audio input with converted text into one or more intervals based on one or more time stamps. In an embodiment herein, the voice optimization module 112 can predict language from the converted text. In an embodiment herein, the audio can be converted from the audio with noise removed into text using a DeepSpeech model. The splitting the audio input may include detecting one or more languages spoken in the audio with noise removed, and detecting a timing of the one or more languages spoken in the audio with noise removed; and determining the one or more intervals based on the timing of the one or more languages spoken and the one or more time stamps.

In an embodiment herein, the audio-to-text correlation module 114 can extract one or more emotions from the split audio input. In an embodiment herein, the audio-to-text correlation module 114 can extract the emotions from the split audio with the predicted language text using a trained emotion transcript comprising a CNN. The audio-to-text correlation module 114 can identify one or more facial features from the extracted emotions. The facial features can include, but no limited to sender looks, skin colour, gender, hair style and expressions. In an embodiment herein, the audio-to-text correlation module 114 can extract one or more features of the user from one or more media files stored in the electronic device 100. The media files can include, but not limited to one or more images, one or more videos. The features can include, but not limited to at least one of the facial features, and one or more object features. The object features include one or more objects worn by the user such as turban, specs, ornaments, and so on. The features are extracted from the images from among the one or more media files. The images may be determined based on at least one of mood, and timestamp of the audio input. The audio-to-text correlation module 114 can create a parcel using the extracted features of the user.

A ‘parcel’ refers to a structured data package containing detailed user-specific visual features—such as facial attributes, skin tone, accessories, and expressions. In this context, the term ‘parcel’ may also be referred to as a feature package, user descriptor, or visual profile, as it encapsulates a comprehensive set of extracted user attributes for avatar generation.

In an embodiment herein, the emotion-driven expression module 116 can pass the extracted emotions and the created Avatar to a comparator. The emotion-driven expression module 116 can suggest one or more expressions from the facial expression database 104, based on a result of the comparator.

In an embodiment herein, the facial expression database 104 comprises a trained facial expression provider module. The facial expression provider module can analyze at least one facial expression from the facial features obtained from the audio-to-text correlation module 114 with a CNN model trained on an expression dataset. In an embodiment herein, the facial expression database 104 is created and trained under user historic data from a gallery of the electronic device 100. The facial expression database 104 can suggest the Avatar expression as per the emotions text received from the created parcel.

In an embodiment herein, the Avatar creation module 118 can create an Avatar using the analyzed facial expression, and the created parcel. The Avatar creation module 118 can create the Avatar by obtaining a media file of the user. The Avatar creation module 118 can animate an Avatar with the identified facial features. In an embodiment herein, the Avatar creation module 118 can map a face of the user using at least one facial recognition method or algorithm, and analyzing the suggested expressions. The Avatar creation module 118 can integrate the one or more extracted expressions with the created Avatar by mapping the extracted emotions to the suggested expressions. The Avatar creation module 118 can integrate real-time reactions with the created Avatar over at least one of the one or more intervals based on the one or more extracted emotions, and sentiment analysis of the converted text using a Natural Language Processing (NLP) model. The Avatar creation module 118 can synchronize lip movements of the Avatar with the audio input. In an embodiment herein, the Avatar creation module 118 can synchronize lip movements of the created Avatar with the audio input based on mapping the converted text to the one or more extracted expressions.

In an embodiment herein, the processor 102 can process and execute data of a plurality of modules of the electronic device 100. The processor 102 can be configured to execute instructions stored in the memory module 108. The processor 102 may comprise one or more of microprocessors, circuits, and other hardware configured for processing. The processor 102 can be at least one of a single processer, a plurality of processors, multiple homogeneous or heterogeneous cores, multiple Central Processing Units (CPUs) of different kinds, microcontrollers, special media, and other accelerators. The processor 102 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 102 of the electronic device 100 can communicate via the communication module 106. The communication module 106 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 108 may comprise one or more volatile and non-volatile memory components which are capable of storing data and instructions of the modules of the electronic device 100 to be executed. Examples of the memory module 108 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 108 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 108 may, in some examples, be considered a non-transitory storage medium. The term “non-transitory” may indicate that the storage medium is not embodied in a carrier wave or a propagated signal. However, the term “non-transitory” should not be interpreted to mean that the memory module 108 is non-movable. In certain examples, a non-transitory storage medium may store data that can, over time, change (for example, in Random Access Memory (RAM) or cache).

FIG. 1 shows example modules of the electronic device 100, but it is to be understood that other embodiments are not limited thereon. In other embodiments, the electronic device 100 may include less or more number of modules. Further, the labels or names of the modules are used only for illustrative purpose and does not limit the scope of the disclosure. One or more modules can be combined together to perform same or substantially similar function in the electronic device 100.

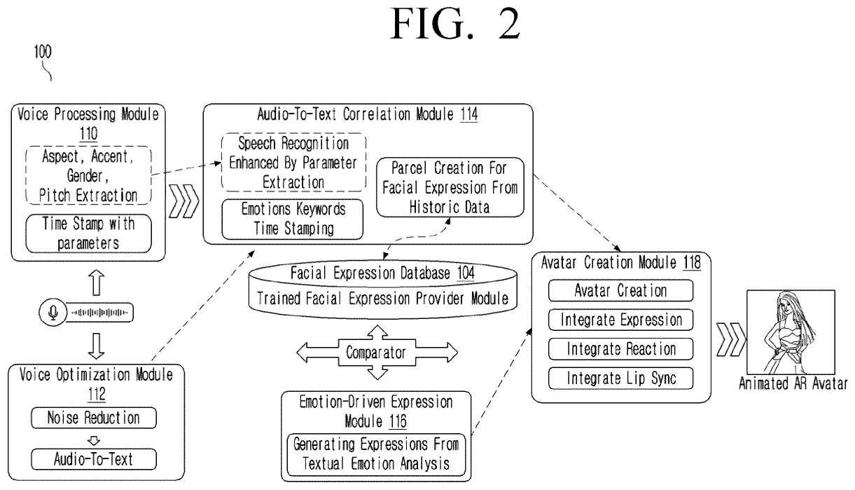

FIG. 2 depicts a detailed system block diagram of the electronic device 100. As depicted, the voice processing module 110 receives the audio input from a user, preprocesses the audio input, and extracts parameters such as an emotional aspect, an accent, a gender, a pitch extraction, and so on. For example, the user records an audio message with his/her mobile phone. The voice processing module 110 adds time stamps to the audio input based on the extracted parameters.

The voice optimization module 112 removes noise from the received audio input, and enhances the audio. The voice optimization module 112 converts the audio with noise removed into text using the DeepSpeech model, and identifies the text language. The voice optimization module 112 inputs the text into language repository with multiple languages to identify the language spoken. The voice optimization module 112 splits the audio input with noise removed into the one or more intervals based on the audio timestamps and the language spoken in an interval.

The audio-to-text correlation module 114 trains the CNN model with multiple emotions based on audio features. The emotions are extracted from the timestamps of audio based on audio and linguistic details. All emotion words that come with time stamp are expressive. Further, with the history of images from gallery of the electronic device 100, facial features of the user are identified, and similar Avatar gets created. The audio-to-text correlation module 114 creates parcel for facial expression from historic data which can be obtained from the facial expression database 104.

The facial expression database 104 is created and trained under user historic data from the gallery of the electronic device 100. The facial expression database 104 suggests the Avatar expression as per the emotions text received from parcel. The parcel gets the expression from the facial expression database 104, where the expressions are suggested to the comparator.

The emotion-driven expression module 116 segregates emotions, and the emotions are searched in the facial expression database 104 with respect to timestamps. The emotion-driven expression module 116 compares the emotions extracted from the split audio with predicted language text from the emotion transcript model with the created Avatar, and suggests expressions from the facial expression database 104, based on the compared emotions with the created Avatar.

The Avatar creation module 118 maps the identified expressions to the created Avatar, and suggests expressions from the facial expression database 104 for correlation. Avatar emotes the expressions within the timeframe throughout the audio message input. The Avatar creation module 118 further animates the Avatar to synchronize lip movements with the audio. The Avatar creation module 118 ensures that the Avatar facial expressions and lip movements are synchronized with the audio and emotions.

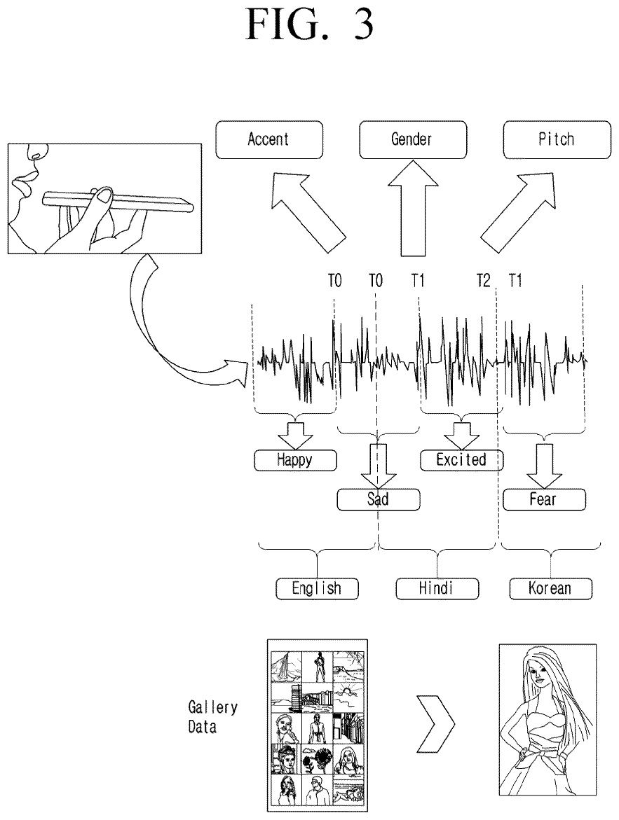

FIG. 3 depicts an example flow representation of extracting parameters and predicting spoken language from the audio input. The voice processing module 110 extracts parameters such as accent, gender, and pitch from the audio input. The voice optimization module 112 splits the audio input with converted text into intervals based on time stamps, identifies the text language, and inputs the text into language repository with multiple languages to identify the language spoken. The audio-to-text correlation module 114 can extract emotions such as happy, sad, excited, and fear from the split audio input. The facial expression database 104 suggests an Avatar expression as per the emotions text received from a created parcel and gallery data of the user, and the Avatar is created.

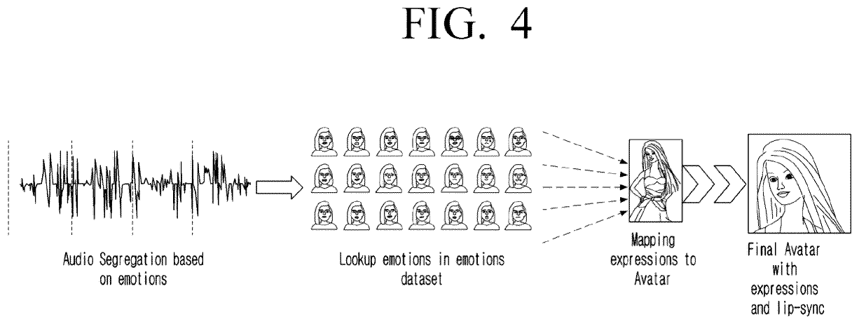

FIG. 4 depicts an example block flow representation of an Avatar creation using the Avatar creation module 118. The audio input is segregated based on emotions, and emotions are correlated from emotions dataset. The Avatar creation module 118 maps expressions to Avatar, and animates the final Avatar with expressions and lip-sync.

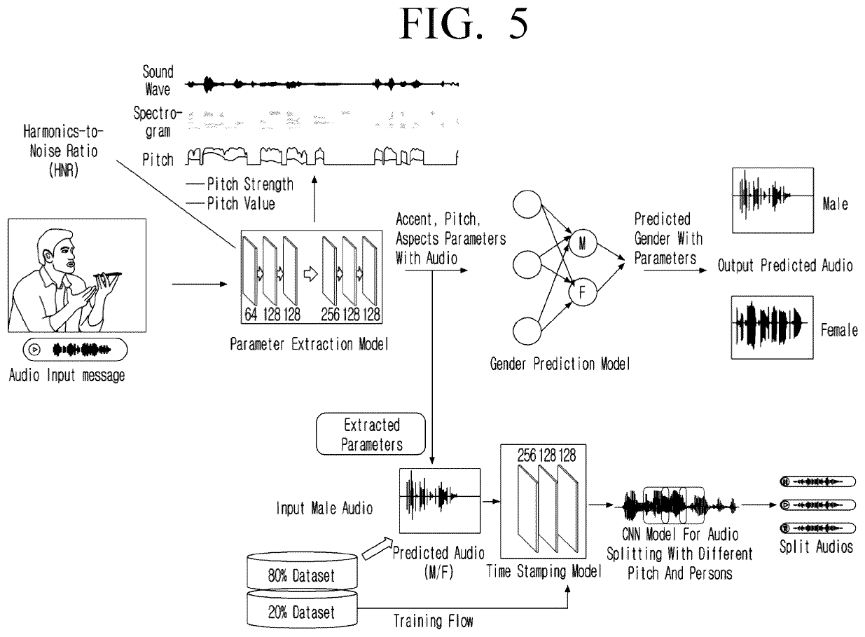

FIG. 5 depicts an example block flow representation of the voice processing module 110 for gender prediction and audio splitting with different pitch and persons. After receiving the audio input message, the voice processing module 110 uses a parameter extraction model and extracts parameters such as accent, pitch, gender and emotional aspects parameters based on the Harmonics-to-Noise Ratio (HNR). HNR measures the amount of noise in the voice signal, which can vary by gender. The pitch of audio is found with the help of sound waves, and CNN is trained under accent detection dataset to predict accent. For example, men typically have lower pitch ranges compared to women. Resonant frequencies of the vocal tract, which differ between genders due to anatomical differences, can be identified by the CNN model. The CNN model helps to identify accent and pitch of audio based on the resonant frequencies.

The voice processing module 110 uses a gender prediction model for predicting gender with parameters. The gender prediction model uses CNNs and RNNs to predict the gender.

The voice processing module 110 predicts the gender from the audio input using extracted parameters, and 80% of pitch datasets. The voice processing module 110 trains a time stamping model using 20% of pitch datasets. Time stamping process is performed by the time stamping model based on the extracted parameters and number of speakers, and the time stamping model is trained under different pitch datasets. Further, audio is split with different pitch and persons, using the CNN model.

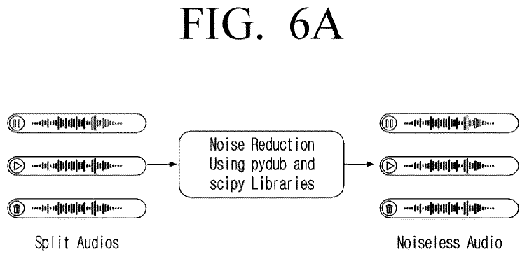

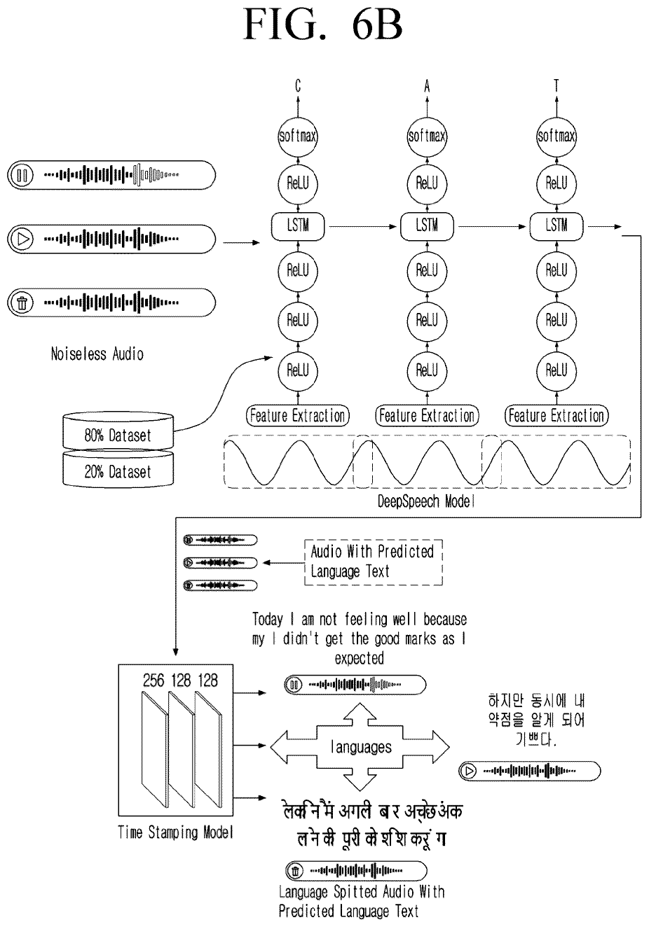

FIG. 6A depicts an example block flow representation of the voice optimization module 112 for noise reduction. The voice optimization module 112 uses various audio processing libraries to remove noise from an audio file before understanding the language. For example, Python with ‘pydub’ library can be used for noise reduction, and ‘scipy’ can be used for further processing.

After removing noise from split audios, the voice optimization module 112 converts the noiseless audio into text using a DeepSpeech model that can predict multiple languages from split audios.

FIG. 6B depicts an example block flow representation of the voice optimization module 112 for predicting languages. The DeepSpeech model helps to convert the noiseless audio into text, and in addition the DeepSpeech model is trained with language dataset for predicting different languages using text. That is, the DeepSpeech model is trained on multiple languages, which helps in detecting words more accurately. Audio with predicted language text is sent to the time stamping model for time stamping the time converted text with respect to languages, speakers, and pitch.

The DeepSpeech model can be considered a type of speech-to-text (STT) model. The DeepSpeech model is merely one embodiment of the present disclosure. Other types of Speech-to-Text (STT) models can also be used to convert noiseless audio into text.

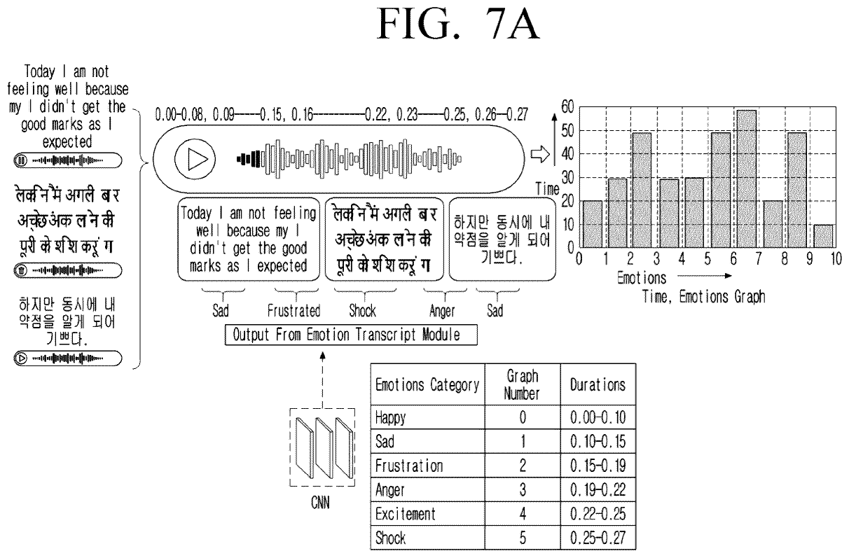

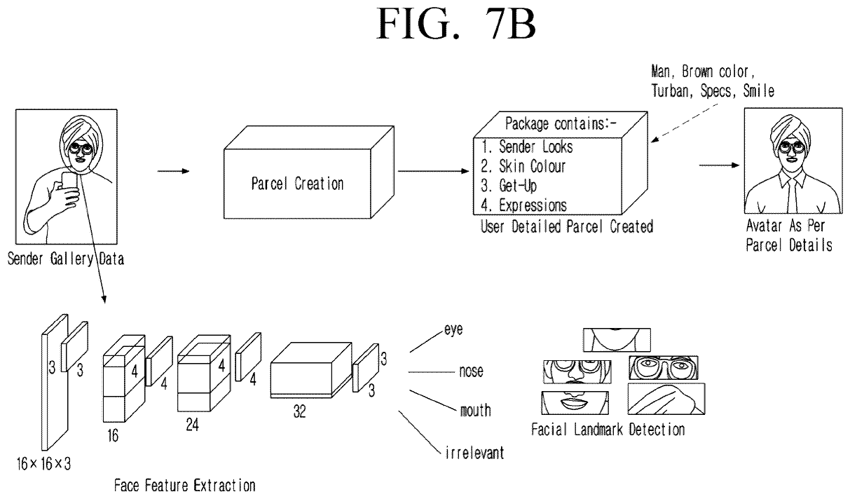

FIG. 7A depicts an example block flow representation of generating a time emotions graph by the audio-to-text correlation module 114. After extracting parameters such as emotional aspect, accent, gender, and pitch, the parameters are aligned with corresponding text using the audio-to-text correlation module 114. The audio-to-text correlation module 114 performs time annotation of the parameters aligned text with emotional aspects. The time annotated parameters are applied on time emotions graph where the time duration is marked as per the emotions generated in text and the pitch of speakers. For example, the emotion transcript model converts the transcript language text into emotions like sad, happy, anger, and so on. The audio emotions are categorized with respect to time in the emotions category graph.

In an embodiment herein, the emotion transcript model includes a trained CNN under emotion keywords. The emotion transcript model picks the audio text and categories into emotions on the bases of transcript text meaning with time stamps.

For example, for the audio input “Today I am not feeling well because I didn't get good marks as I expected”, the audio input has a low pitch, received from female in English language. The audio input is split in time stamps, and emotion identified as “sad” from the text “not feeling well”.

For example, for the audio input “Brother I won today's football match and I score 2 goals”, the audio input has a high pitch, received from male, in English language. The audio input is split in time stamps, and emotion identified as “happy” from the text “I won today's football”.

In an embodiment herein, the audio-to-text correlation module 114 fetches audio sender face details from historic data. The audio sender face describes how sender face looks and body structure during the extracted audio emotion situation. For example, the audio-to-text correlation module 114 uses a user feature extraction model for creating a parcel using a sender gallery data. The parcel contains user face looks, details, body structure from his/her historic data from gallery which can be further used for Avatar creation.

FIG. 7B depicts an example block flow representation of a parcel creation module of the audio-to-text correlation module 114. The parcel creation module is trained under object feature extraction dataset where the trained module helps to extract the face feature and other essentials. For example, for a person who wears turban and specs, the parcel contains whole details which helps to create Avatar in more detail way. The parcel creation module uses a face feature extraction model for extracting face features with the landmark of the face which can be further used to map into an Avatar creation module 118. The parcel creation module creates a user detailed parcel that contains a package of sender looks, skin colour, get-up, and expressions. The features considered for parcel creation include man, brown color, turban, specs, and smile. Further, Avatar is created as per parcel details.

In an embodiment herein, the user feature extraction model is created using the CNN model and Rectified Linear Unit (ReLU) to extract features from a user image. The user feature extraction model is connected with flatten layer which performs classification task, and passes the classified output to fully connected layer for creating a feature which contains required features of the user. For example, convolution layers help in detecting and extracting basic to complex features from images, while ReLU ensures that the network can handle non-linear relationships and effectively learn from the data. Together, the convolution layers and the ReLU enable the CNN to extract meaningful features from user images. Flatten and fully connected layers bridge the gap between the feature extraction part of the CNN, and the final output generation for parcel creation.

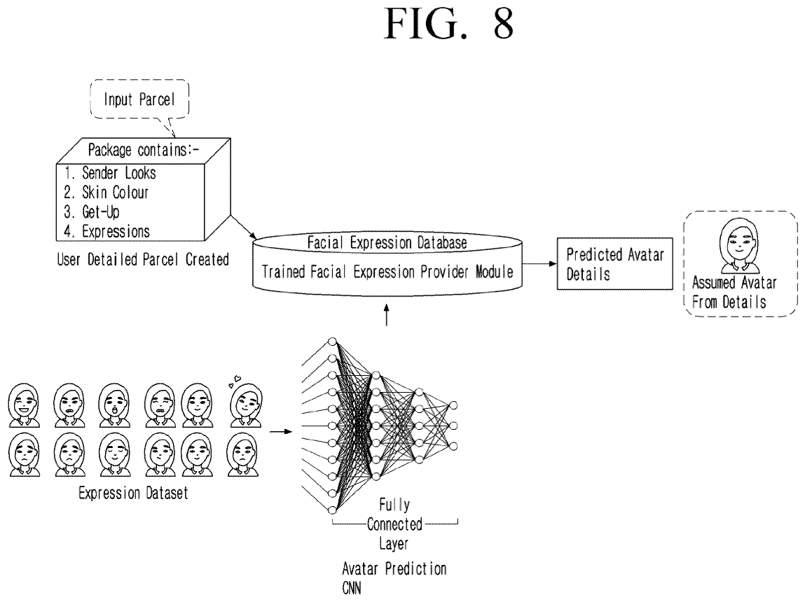

FIG. 8 depicts an example block flow representation of the trained facial expression provider module of the facial expression database 104. Here, the CNN Model is trained under user expression dataset, and stored into the facial expression database 104 which is further used for Avatar face creation part. For example, the CNN model is trained under expression dataset, applying techniques like data augmentation to enhance robustness. Use validation and test sets to tune the model, and ensure that the model generalizes well to new data. The facial expression provider module inputs a new facial expression into the trained CNN model to generate the corresponding Avatar. The Avatar is created with the help of user historic data which was fetched previously and expression is suggested as per default looks.

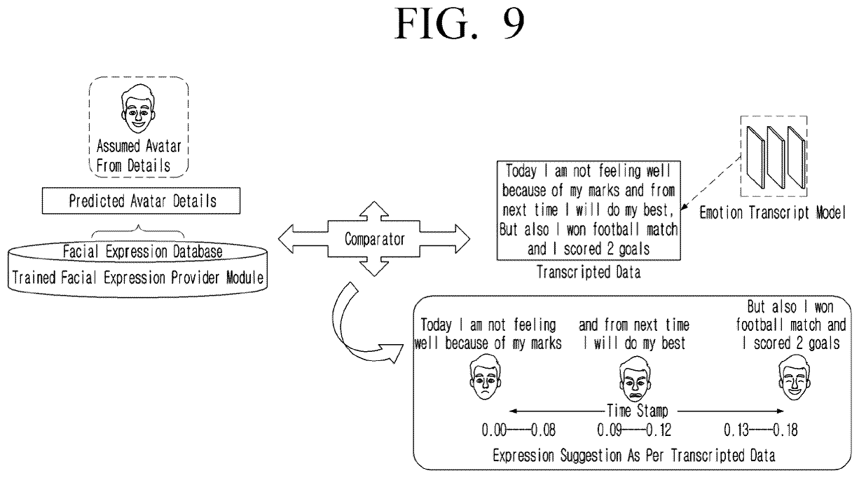

FIG. 9 depicts an example block flow representation of the emotion-driven expression module 116. The emotion-driven expression module 116 receives data from the emotion transcript model, and checks the audio transcript data is in the facial expression database 104. The facial expression database 104 suggests Avatar expression according to transcript data. The emotion-driven expression module 116 uses the comparator for comparing the suggested Avatar with transcript data which was extracted from the emotion transcript model, and suggesting expressions from the facial expression database 104 with the Avatar. The suggested expression is based on emotions with time stamp as per transcript data text. For example, for audio input “Today I am not feeling well because of my marks and from next time I will do my best, But also I won football match and I scored 2 goals”, three expressions are suggested. First expression is for “Today I am not feeling well because of my marks”, second expression is for “and from next time I will do my best”, and third expression is for “But also I won football match and I scored 2 goals”.

In an embodiment herein, the Avatar creation module 118 creates Avatar by image acquisition, facial landmark detection, and expression analysis. The Avatar creation module 118 starts with a clear, and high-quality image of the user. This image provides the basis for the Avatar's appearance. The Avatar creation module 118 uses facial recognition algorithms to identify key landmarks on the user's face, such as eyes, nose, mouth, and jawline. The Avatar creation module 118 uses a linear detector for identifying facial landmarks. This helps in accurately mapping face. The Avatar creation module 118 analyzes the expression data set which is received from comparator. The analyzed expression data set contains various facial expressions and their corresponding features. This data helps in understanding how different expressions alter the face as per emotion texts. Morph animation is performed for Avatar creation. The morph animation involves transitioning between different shapes or models (morph targets) to create smooth animations. Each morph target has corresponding vertices, allowing for interpolation between them. The created Avatar looks, colour, get-up hair style and beard can be get decided from linear detector which get the information from parcel, where the parcel is extracted from user images. Further, the Avatar creation module 118 uses an expression analysis model that provides user's default facial expression.

In an embodiment herein, the comparator compares the emotion information extracted from the emotion transcript model with the Avatar expression data suggested from the facial expression database 104. The comparator performs a matching process based on emotional categories (e.g., anger, sadness, joy, surprise) and selects an appropriate expression corresponding to the detected emotion. For example, when the transcript data indicates an “anger” emotion, the comparator selects an angry expression stored in the facial expression database 104 and provides the selected expression to the Avatar creation module 118. In this manner, the comparator enables the Avatar to reflect expressions aligned with the user's emotions, and the suggested expressions can be further synchronized with the time stamps of the transcript data so that the Avatar's expressions change dynamically along the conversation flow.

In an embodiment herein, the Avatar creation module 118 maps emotions to expressions by creating a time emotions graph of morph targets or predefined facial expressions for different emotions (for example, joy, anger, sadness). The time, emotions graph is fetched to map the expression as per text emotions on Avatar. Emotion mapping on Avatar is performed as per category. For instance, a happy emotion might map to a smiling expression, while a sad emotion maps to a frowning expression. Further, the Avatar is trained with emotions, and the trained Avatar is integrated with reaction time.

In an embodiment herein, the Avatar creation module 118 performs sentiment analysis and real-time emotion detection for integrating reaction to the Avatar. The Avatar creation module 118 performs sentiment analysis by using NLP to analyze text-based feedback. This feedback or emotions text is extracted from the emotion transcript model. The emotion-driven expression model detects emotions from user facial expressions. This model suggests real-time emotions with time stamp which helps model to react the Avatar as per emotions. The Avatar creation module 118 performs filtering for emotion morphed Avatar for smooth out rapid changes or noise in output reaction. Avatar is provided with the transcript data and expression data with time stamp which helps to react at real time, for integrating best reaction to the Avatar on that particular time period.

In an embodiment herein, the Avatar creation module 118 maps the audio text with expression using a smooth Avatar neural network. During the process, time stamp will be the parameter which is tracked with audio text. The Avatar creation module 118 integrates the lip sync to the Avatar for the mapped audio text.

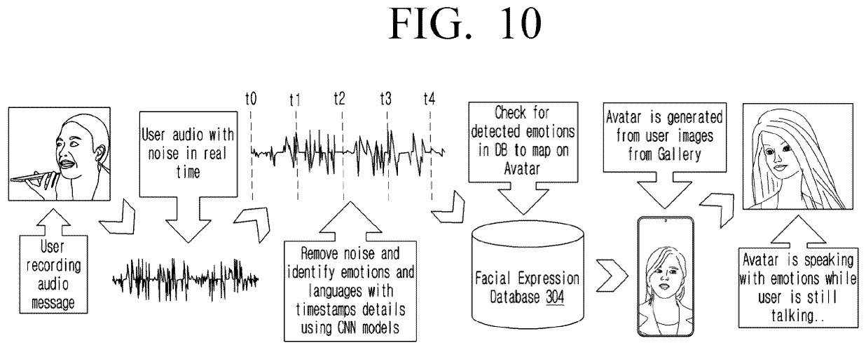

FIG. 10 depicts an example flow representation for generating a real-time voice based Avatar interaction by the electronic device 100. When the user records audio message, the audio may have noise. The electronic device 100 removes noise, and identifies emotions and languages with timestamps details using CNN models. The electronic device 100 checks for detected emotions in the facial expression database 104 to map on Avatar. Avatar is generated from user images from gallery. Finally, Avatar speaks with emotions while user is still talking.

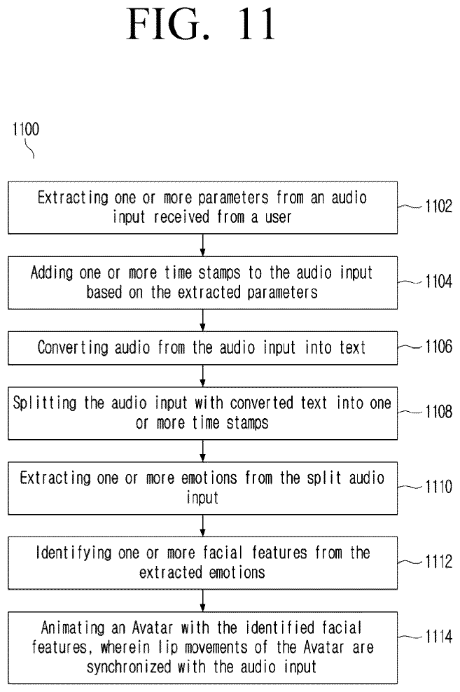

FIG. 11 depicts a method 1100 for generating a real-time voice based Avatar interaction by the electronic device 100. The method 1100 comprises extracting one or more parameters from an audio input received from a user, as depicted in step 1102. Later, the method 1100 comprises adding one or more time stamps to the audio input based on the extracted parameters, as depicted in step 1104. The method 1100 comprises converting audio from the audio input into text, as depicted in step 1106. Thereafter, the method 1100 comprises splitting the audio input with converted text into one or more intervals based on the one or more time stamps, as depicted in step 1108. The method 1100 comprises extracting one or more emotions from the split audio input, as depicted in step 1110. The method 1100 comprises identifying one or more facial features from the extracted emotions, as depicted in step 1112. Later, the method 1100 comprises animating an Avatar with the identified facial features, and lip movements of the Avatar are synchronized with the audio input, as depicted in step 1114.

The various actions in method 1100 may be performed in the order presented, in a different order or simultaneously. Further, in some embodiments, some actions listed in FIG. 11 may be omitted.

In a use case of sending audio messages using audio Avatar, while sending simple audio message is so non-emotional, and without expression, instead user can record and send audio messages through their Avatars, which are played back with synchronized lip movements and facial expression. This can be done by using sender's Avatar which looks like sender's look, and lips moment is controlled from his/her words.

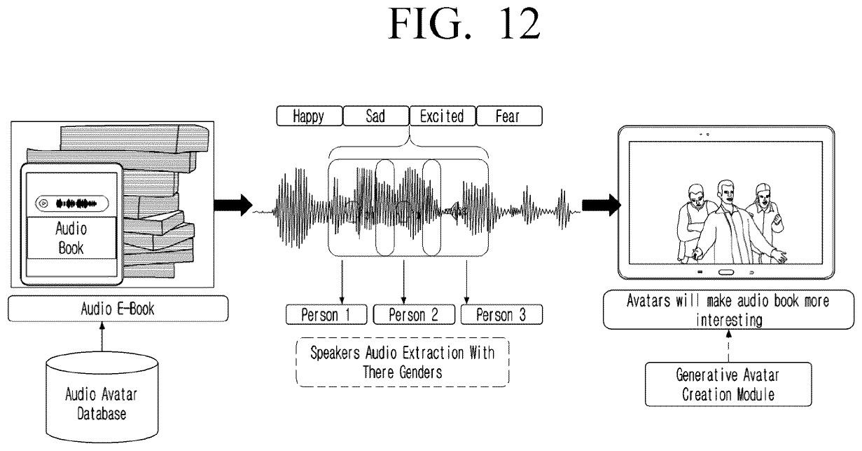

FIG. 12 depicts a use case of E-Books and E-learning. Many people enjoy listening to audio E-Books, and proposed methods 1100 may be integrated with audio books, helping users to better understand the audio book, and to make the audio book more interesting. Educators use audio books to deliver lectures, and interact with students via audio messages. The proposed methods 1100 help the user to understand better, and enjoy more understanding hearing session while listening audio book or E-Book.

In a use case of video calling using Avatar, users who are not comfortable in video call or users who don't use camera while in video call, can switch to audio Avatar mode. Other users can see the Avatar with lip movements, and facial expression in sync. This enhances user experience. For example, when user turns off the camera in the video call, the user is shown with the user Avatar talking. In another example, when user turns off the camera during meeting, automatically his/her Avatar starts representing. The proposed methods 1100 improve the lip sync by enhancing integrating voice processing model, and by adding audio emotion mode with time stamp which helps to be more accurate, and Avatar is trained under user image historic data.

Therefore, the proposed methods 1100 integrate a user Avatar when sending audio messages, and enhance communication by conveying emotions more effectively through audio. The proposed methods 1100 transform e-book characters into Avatars that can explain the situation, and emotions of the characters in the e-book. The proposed methods 1100 convert the video call feature to an Avatar video call when the user turns off the camera. The proposed methods 1100 integrate Avatar mode for gamers during audio conversations or use Avatars in virtual meetings.

The embodiments disclosed herein can be implemented through at least one software program running on at least one hardware device. The elements include blocks which can be at least one of a hardware device, or a combination of hardware device and software module.

The embodiments disclosed herein describe electronic device 100 and methods 1100 for improving user interaction and engagement through user Avatar with audio message integration. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A method for generating a real-time voice based Avatar interaction, performed by an electronic device, comprising:
extracting one or more parameters from an audio input received from a user;
adding one or more time stamps to the audio input based on the one or more extracted parameters;
converting audio from the audio input into text;
splitting the audio input with converted text into one or more intervals based on the one or more time stamps;
extracting one or more emotions from the split audio input;
identifying one or more facial features from the one or more extracted emotions; and
animating an Avatar with the identified one or more facial features such that lip movements of the Avatar correspond with the audio input.

2. The method as claimed in claim 1, wherein the one or more extracted parameters comprise at least one of: an emotional aspect, an accent, a gender, and a pitch, and wherein the one or more parameters are extracted based on a Harmonics-to-Noise Ratio (HNR) using a Convolutional Neural Network (CNN) model.

3. The method as claimed in claim 1, wherein the one or more time stamps are added to the audio input by splitting the audio based on at least one person dataset or pitch dataset.

4. The method as claimed in claim 1, further comprising removing noise from the received audio input, and
wherein the converting the audio into text comprises converting the audio with noise removed into text.

5. The method as claimed in claim 4, wherein the audio with noise removed is converted into text using a DeepSpeech model, and wherein the splitting the audio input comprises:
detecting one or more languages spoken in the audio with noise removed, and detecting a timing of the one or more languages spoken in the audio with noise removed; and
determining the one or more intervals based on the timing of the one or more languages spoken and the one or more time stamps.

6. The method as claimed in claim 1, wherein the method further comprises:
predicting a spoken language from the converted text;
splitting the audio input with the converted text into the one or more intervals based on the spoken language; and
extracting the one or more emotions from the split audio using an emotion transcript model comprising a CNN.

7. The method as claimed in claim 1, wherein the method further comprises:
extracting one or more features of the user from one or more media files stored in the electronic device, wherein the one or more features comprise at least one of the one or more facial features, and one or more object features; and
creating a parcel using the one or more extracted features of the user.

8. The method as claimed in claim 7, wherein the one or more features are extracted from one or more images from among the one or more media files, and wherein the one or more images are determined based on at least one of mood, and timestamp of the audio input.

9. The method as claimed in claim 7, wherein the method further comprises:
analyzing at least one facial expression from the one or more facial features with a CNN model trained on an expression dataset; and
creating the Avatar using the analyzed at least one facial expression, and the created parcel.

10. The method as claimed in claim 9, wherein the method further comprises:
passing the one or more extracted emotions and the created Avatar to a comparator; and
suggesting one or more expressions from a facial expression database, based on a result of the comparator.

11. The method as claimed in claim 9, wherein the Avatar is created by based on a media file of the user, and wherein the animating the Avatar comprises:
mapping a face of the user using at least one facial recognition method;
integrating the one or more extracted expressions with the created Avatar by mapping the one or more extracted emotions to the one or more suggested expressions;
integrating real-time reactions with the created Avatar over at least one of the one or more intervals based on the one or more extracted emotions, and sentiment analysis of the converted text using a Natural Language Processing (NLP) model; and
synchronizing lip movements of the created Avatar with the audio input based on mapping the converted text to the one or more extracted expressions.

12. An electronic device, comprising:
at least one processor; and
memory storing instructions;
wherein the instructions, when executed by the at least one processor, individually or collectively, cause the electronic device to:
extract one or more parameters from an audio input received from a user;
add one or more time stamps to the audio input based on the one or more extracted parameters;
convert audio from the audio input into text;
split the audio input with converted text into one or more intervals based on the one or more time stamps;
extract one or more emotions from the split audio input;
identify one or more facial features from the one or more extracted emotions; and
animate an Avatar with the identified one or more facial features such that lip movements of the Avatar correspond with the audio input.

13. The electronic device as claimed in claim 12, wherein the one or more extracted parameters comprise at least one of: an emotional aspect, an accent, a gender, and a pitch, and wherein the one or more parameters are extracted based on a Harmonics-to-Noise Ratio (HNR) using a Convolutional Neural Network (CNN) model.

14. The electronic device as claimed in claim 12, wherein the one or more time stamps are added to the audio input by splitting the audio based on at least one person dataset or pitch dataset.

15. The electronic device as claimed in claim 12, wherein the instructions, when executed by the at least one processor, individually or collectively, cause the electronic device to remove noise from the received audio input and convert the audio with the noise removed into text.

16. The electronic device as claimed in claim 15, wherein the audio with noise removed is converted into text using a DeepSpeech model, and wherein the instructions, when executed by the at least one processor, individually or collectively, cause the electronic device to:
detect one or more languages spoken in the audio with noise removed, and detect a timing of the one or more languages spoken in the audio with noise removed; and
determine the one or more intervals based on the timing of the one or more languages spoken and the one or more time stamps.

17. The electronic device as claimed in claim 12, wherein the instructions, when executed by the at least one processor, individually or collectively, cause the electronic device to:
split the audio input with the converted text into the one or more intervals based on the spoken language;, and
extract the one or more emotions from the split audio using an emotion transcript model comprising a CNN.

18. The electronic device as claimed in claim 12, wherein the instructions, when executed by the at least one processor, individually or collectively, cause the electronic device to:
extract one or more features of the user from one or more media files stored in the memory, wherein the one or more features comprise at least one of the one or more facial features, and one or more object features; and
create a parcel using the one or more extracted features of the user.

19. The electronic device as claimed in claim 18, wherein the one or more features are extracted from one or more images from among the one or more media files, and wherein the one or more images are determined based on at least one of mood, and timestamp of the audio input.

20. A non-transitory computer-readable recording medium having at least one instruction recorded thereon, that, when executed by at least one processor, individually or collectively, causes the at least one processor to:
extract one or more parameters from an audio input received from a user;
add one or more time stamps to the audio input based on the one or more extracted parameters;
convert audio from the audio input into text;
split the audio input with converted text into one or more intervals based on the one or more time stamps;
extract one or more emotions from the split audio input;
identify one or more facial features from the one or more extracted emotions; and
animate an Avatar with the identified one or more facial features such that lip movements of the Avatar correspond with the audio input.
